(19) United States
(12) Patent Application Publication
(10) Pub. No.: US 2018/0285182 A1
(43) Pub. Date: Oct. 4, 2018

(54) DEFECT ASSESSMENT

(71) Applicant: ENTIT Software LLC, Sunnyvale, CA (US)

(72) Inventors: Omer Frieman, Yehud (IL); Avigad Mizrahi, Yehud (IL); Simon Rabinowitz, Yehud (IL)

(21) Appl. No.: 15/760,996

(22) PCT Filed: Sep. 25, 2015
(86) PCT No.: PCT/US2015/052285

§ 371 Date: Mar. 16, 2018

(51) Int. Cl. G06F 11/07; G06F 11/30; G06F 11/34

(52) U.S. Cl. CPC G06F 11/079; G06F 11/0751; G06F 11/3452; G06F 11/302; G06F 11/3438; G06F 11/0787

(57) ABSTRACT

Defect assessment includes assessing a defect severity using extracted analytic cats from an analytic engine generated by a set of recorded steps for an application. Customer usage of the application is monitored to generate usage statistics over a time period from the analytic engine including a image factor and a bounce rate factor. An ongoing severity level from a mixture of the usage factor and the bounce rate factor is calculated.

### BACKGROUND

One goal of software application testing is to find defects. A defect causes an application to behave in an unexpected manner. The unexpected manner may be due to errors in coding, a lack of an expected program requirement, an undocumented feature, and other anomalies. Most application testing is done to show that the application performs properly, however, an effective test will show the presence and not the absence of defects. Application testing is typically done with both the application software developers (DevOps) and an independent testing team of quality assurance engineers (QAEs). Despite considerable management, engineering, and monetary resources dedicated to testing applications, most applications today still ship with several defects per thousand lines of code.

### BRIEF DESCRIPTION OF THE DRAWINGS

The disclosure is better understood with reference to the following drawings. The elements of the drawings are not necessarily to scale relative to each other. Rather, emphasis has instead been placed upon clearly illustrating the claimed subject matter. Furthermore, like reference numerals designate corresponding similar parts through the several views.

FIG. 1 is an example environment for defect assessment of an application under test (AUT) that may have one or more defects;

FIG. 2 is an example method for assessing defects by a defect recording assessment (DRA) tool;

FIG. 3 is an example screenshot of analytical data with usage statistics used in one exemplary implementation of a DRA tool that allows for continuous monitoring and assessment of customer usage of an AUT;

FIG. 4 is an example flow chart of a technique to calculate a set of results including the severity level of a defect using the usage statistics;.

FIG. 5 is an example non-transitory computer readable medium for storing instructions for defect assessment in a DRA tool; and

FIG. 6 is an example block diagram of a computer based system implementing a DRA tool with a defect recording assessment program.

### DETAILED DESCRIPTION

As noted, defects are a common problem in application creation and other software development. Finding such defects is typically a manual process that takes considerable amounts of time and resources. For instance, quality assurance engineers (QAEs) and software developers (DevOps) not only have to spend their time using an application but also need to document how to repeat the defect and subjectively classify how severe the particular defect is with respect to other defects, in medium and large software applications there may be a large accumulation of defects in the application backlog. Accordingly, when the software creation process is done using continuous delivery or agile software development, management has to assess and plan the distribution of available resources, including development hours carefully. In addition, as a defect is a departure from an expectation, it is important to understand the expectations of the users of the application rather the DevOps/QAEs themselves, which may have different priorities and beliefs about how severe a defect is with respect to the overall application. For instance, a DevOp may believe a particular defect is severe and want to prevent release of a new revision, however, analysis of the user flows may determine that the defect is rarely, if ever, encountered by the users of the application. Further, over time with a users application use and with various updates, the expected severity level may continually change.

Accordingly, this disclosure describes and teaches an improved system and method for defect assessment of severity. The method provides an automatic way to objectively classify the severity level of a defect using a combination of real-time and historical analytical information, including real-time customer usage. The described solution includes (1) recording a set of user interface steps taken to produce the defect, (2) automatically opening a defect report in a defect management system and attaching the recording to the defect, and (3) assessing the defect severity level using one or more analytic engine calls and usage information from hosted web-based or stand-alone analytic engine providers. The analytic calls and usage information includes user flows and bounce rate. The bounce rate is the percentage of visits that are single page visits.

More specifically, a tester provides a set of recorded steps to a defect assessment tool that takes those recorded steps and extracts a set of analytic cells from an analytic engine, such as Google Analytics or others that monitor the recorded steps in user flows within a live environment. A customer's use of the recorded steps may be monitored and assessed dynamically over time using usage statistics from the analytic engine to create an objective based severity level rating. The statistics from the analytic engine are used to create a Usage Factor for the recorded steps and a Bounce Rate Factor for users of the recorded steps. These two factors are representative of the recorded steps with respect to the overall application use and also with respect to the overall number of clicks and overall users. The Usage Factor and the Bounce Rate Factor can be weighted and combined; to create an overall severity level that is compared to a threshold to determine various criticality ratings or actions to be taken. These factors may also be normalized as needed to account for various application usage models among different users.

Consequently, the defect assessment tool provides an objective method based on customer usage of the application. By monitoring how a customer is using the application, a defect may be deemed serious if the user uses the feature with the defect and then abandons its use (Bounce Rate) or it may be deemed non-serious f the particular feature with the defect is never used (Usage).

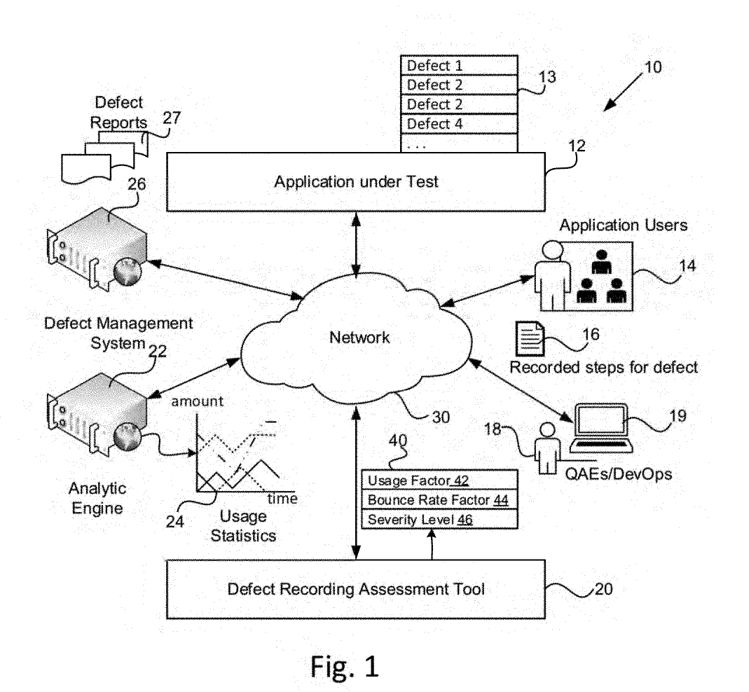

FIG. 1 is an example environment 10 for defect assessment of an application under test (AUT) 12 that may have one or more defects 13. A defect recording assessment tool 20 is used to provide a set of results 40 by a quantifiable method to classify defect severity levels 46 using a combination of real-time and historical analytical information, such as a Usage Factor 42 and Bounce Rate Factor 44, with a web-based or other analytic engine 22. Several different analytic engines 22 feat track and report website traffic are known to those of skill in the art and include “Google Analytics”™, Insight™ and SiteCatalyst™ (Omniture™ (“Adobe Systems”™), and “Yahoo! Web Analytics”™ to Just name a few. Analytic Engines 22 may be stand-alone applications or hosted as software as a service (SaaS). The analytic engine 22 generally communicates with the AUT 12 over a communication channel, such as network 30. Network 30 may be an intranet, Internet, virtual private network, or combinations thereof and may be implemented using wired and/or wireless technology, including electrical and optical communication technologies, in some examples, the analytic engine 22 may be directly connected to AUT 12 by a communication channel that is a simple or non-network, such as USB 2.0, USB 3.0, Firewire™, Thunderbolt™, etc. The analytic engine 22 provides one or more sets of usage statistics 24 that typically show variation of application customers' or users' 14 use of the application over time for various tracked events.

QAEs/DevOps 18 are able to communicate with AUT 12 via network 30, typically with a workstation 19. QAWs/DevOps 18 may also communicate their findings and results with a defect management system 26, such as “HP's Agile Manager”™. The defect management system 26 may be integrated with or separate from the defect recording assessment tool 20. During testing, the QAEs/DevOps 18 document their defect findings for each of the defects 13 by creating a recorded steps 16 document for defect 13 on defect recording analysis (DRA) tool 20 or workstation 19. The DRA tool 20 then opens a new defect report 27 in defect management system 26 and analyzing over time the severity level 46 or severity rating of the defect 13 using the analytic engine's 22 statistics 24.

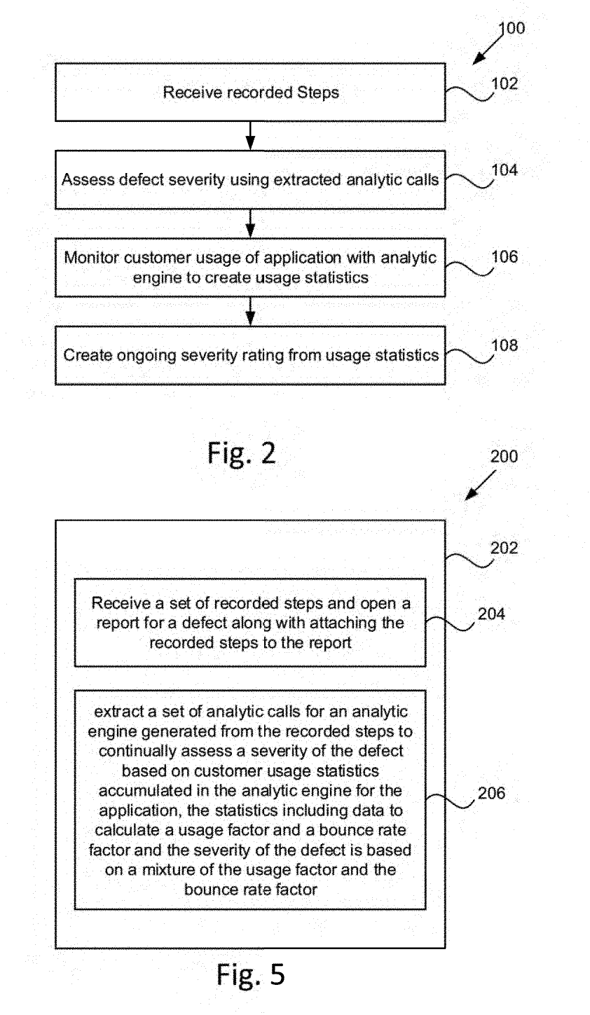

FIG. 2 is an example method 100 for assessing defects by DRA tool 20. In block 102, the DRA tool 20 receives recorded steps 16 to replicate the respective defect 13, such as from QAEs/DevOps 18 or others, possibly users 14 in user forums, 3^{rd} party researchers, etc. DRA tool 20 then in block 104 sets up analytic engine 22 to allow for assessing the defect severity level 46 using extracted analytic calls to analytic engine 22. Customer usage of the AUT 12 is monitored with the analytic engine 22 to create usage statistics in block 106. Then in block 108, the usage statistics are used to create an ongoing severity level 46 for the defect 13.

In one example, a QAE/DevOp 18 encounters a problem while manually testing an application. The QAE/DevOp 18 then records the graphical user interface (GUI) or other user interface steps taken to produce the defect 13. For instance, one example set of steps might be “click button”, “select box”, “navigate down”, etc. The recording system may be built into the DRA tool 20 or may be done in a separate utility too! such as “HP's TruClient”™ or “Selenium”™ as just a couple of examples. The DRA tool 20 opens a defect report 27 and attaches the recorded steps 16 for defect 13 in defect management system 26. The DRA tool 20 extracts analytic calls generated by the recorded steps when the recorded flow of user interface steps are executed in a live environment. For example, with “Google Analytics”™ and a flow of recorded steps 16 such as “enter login page, enter home page, enter new user page, and press create new user button”, the following calls to “Google Analytics”™ are extracted and the relevant information is held in the eventLabel parameter;
https://www.google-analytics.com/collect!eventLabel=EnterLoginPage
https://www.google-analytics.com/collect!eventLabel=EnterHomePage
https://www.google-analytics.com/collect!eventLabel=EnterNewUserPage
https://www.google-analytics.com/collect!eventLabel=PressCreateNewUserButton

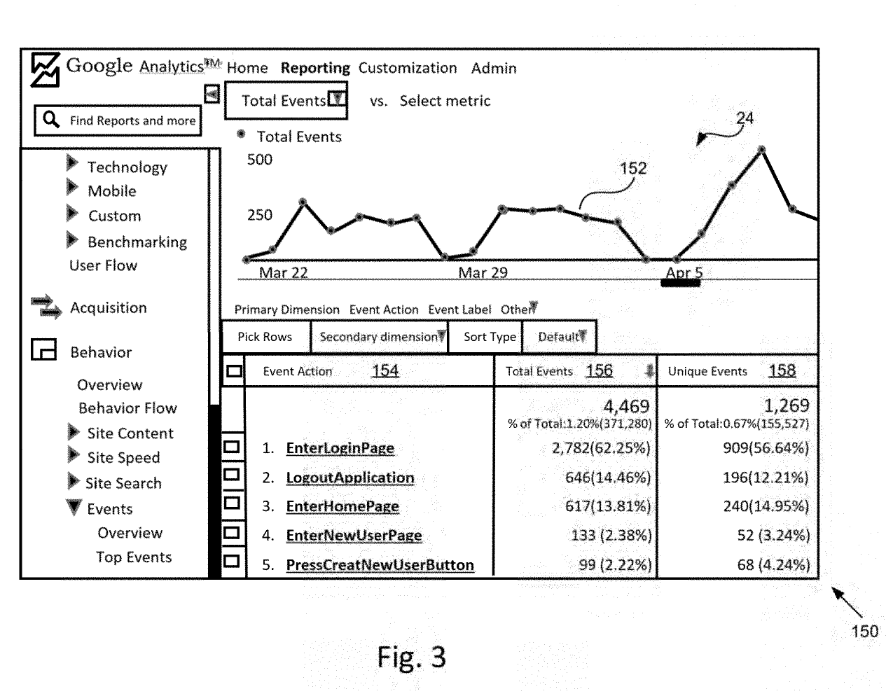

FIG. 3 is an example screenshot 150 of analytical data with usage statistics 24 used in one exemplary implementation of a DRA tool 20 that allows for continuous monitoring and assessment of customer usage of AUT 12 after its release to production. As users begin using the features of the AUT 12, usage statistics 24 are accumulated in the analytic engine 22. Screenshot 150 illustrates example usage statistics 24 for user information in the eventLabels described above over a time period. In total events chart 152, the number of total events is displayed over time. As one can notice, the total number of events varies for each day over about a two week span. The various event actions 154 can be broken down into the separate eventLabels and the separate eventLabels total events 156 and unique events 158.

As the usage statistic's 24 real-time data from the analytic engine 22 changes over time, the severity level 46 classification may he dynamically re-evaluated. For instance, if usage for an eventLabel drops within a period to a lower level that may indicate that the defect 13 is not being experienced by users. In that case, then the DRA tool 20 might consider lowering the defect severity level 46 for the respective eventLabel, Another factor that may be used when classifying severity level 46 is the user bounce rate. As noted previously, the bounce rate is the percentage of visits that are single page visits. That is, when users leave an AUT 12 in this flow of recorded steps, a defect 13 may be upgraded to critical as the user when encountering the defect 13 quits using the particular defect recorded flow.

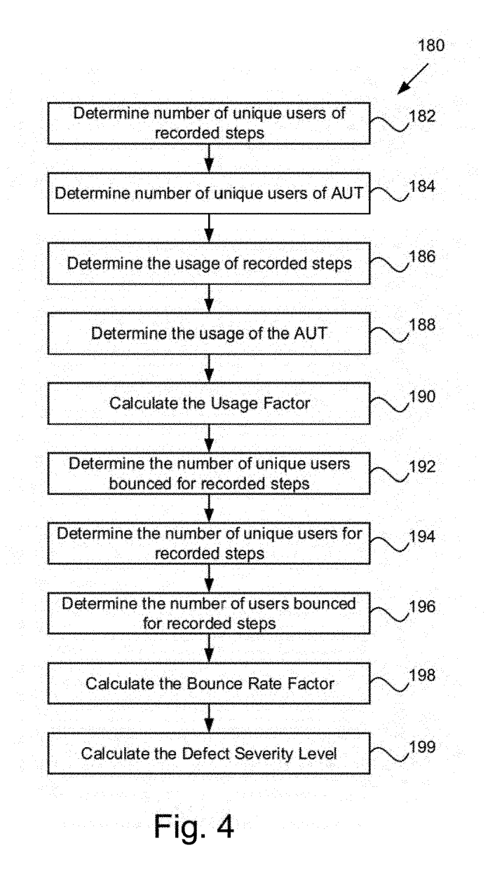

FIG. 4 is an example flow chart of a technique 180 to calculate the set of results 40 including the severity level 46 of a defect 13 using the usage statistics 24. In block 182, the analytic engine 22 statistics 24 are used to determine the number of unique users 14 of recorded steps 16 for the defect 13. In block 184, the number of unique users for AUT 12 is determined. The usage for the recorded steps 16 are determined in block 186 as well as the usage of the AUT 12 determined in block 188. In one example, the usage for the recorded steps 16 is the number of dicks in the measured flow for the recorded steps 16 and the usage for the AUT 12 is the number of clicks in the application. From these four items from statistics 24, the Usage Factor 42 may be calculated in block 190. In one example, the Usage Factor 42 may be calculated as follows:

$$Usage Factor = average ( \frac{\# of unique users of recorded steps}{\# of unique users of AUT} , \frac{usage of recorded steps}{usage of AUT} )$$

Where #=number,
In other examples, rather than averaging the two sub-factors for the Usage Factor 42, they may weighted and summed.

### Example:

Let # of unique users of recorded steps=500:

Let # of unique users of AUT=1000;

Let usage of recorded steps=8000; end

Let usage of AUT=70000.

Then Usage Factor=average (500/1000, 8000/70000)=30.7% a medium usage.

In block 192 the number of unique users 14 bounced for the recorded steps are determined as well as the number of unique users 14 for the recorded steps in block 194. The number of users 14 bounced for the AUT 12 is determined in block 196, in block 198, the Bounce Rate Factor 44 can be calculated from these three sub-factors along with the sub-factor determined in block 186 for the usage of the recorded steps. In one example the Bounce Rate Factor 44 may be calculated as follows:

$$Bounce Rate Factor = average ( \frac{\frac{\# of unique users bounced for recorded steps}{\begin{matrix}\# of unique users for recorded steps \\ \# of users bounced for recorded steps\end{matrix}} ,}{usage of recorded steps} )$$

Where #=number,
In other examples, rather than averaging the two sub-factors for the Bounce Rate Factor 44, they may weighted and summed.

### Example:

Let # of unique users bounce for recorded steps=500;

Let # of unique users for recorded steps=1000:

Let # of users bounced for recorded steps=6000; and

Let usage of recorded steps=8000,

Then Bounce Rate Factor=average (500/1000, 6000/8000)=62.5%, a high rated defect.

In block 199, the severity level 46 of the defect 13 can be calculated from the Usage Factor 42 and the Bounce Rate Factor 44. For instance in one example, the Usage 42 and Bounce Rate 44 Factors are averaged, such as:

Severity Level of Defect=average(Usage Factor, Bounce Rate Factor)

Example: using the two calculated examples for the Usage Factor 42 and the Bounce Rate Factor 44 above:

Then Severity Level of Defect=average (30.7%, 62.5%)=46.6%, a medium severity level.

In other examples, rather than averaging, a weighted sum of the two factors may be used such as:

$$Severity Level of Defect = \frac{X * Usage Factor + Y * Bounce Rate Factor}{Z}$$

In yet other examples, normalization of the two factors may be applied when there is a disproportionality between the number of unique users 14 and the overall usage. For example, if a small number of unique users 14 are the major consumers of the application, the Usage Factor 42 can be multiplied by 1.5 in order to give more accurate weight, in some implementations of the DRA tool, the normalization and weighting factors may be configured by a user and/or owner of the tool. Also, thresholds for factors and defect assessment can be dynamically configured as well for the respective set of results 40. For instance:

If result>=75% mark as critical;

If result>=50% mark as high;

If result>=25% mark as medium;

If result<25% mark as low.

By having the recorded steps 16 available and extracting a set of analytical calls for the ongoing analytical engine 22 usage statistics 24, DevOps 18 can use the DRA tool 20 without having to bother or request the services of the quality assurance teams. Further, the recorded steps 16 may fee used as AUT 12 tests which are periodically executed to assess and determine when the defect 13 was solved, if the defect 13 is indicated as solved, the DRA tool 20 may then automatically close the defect report 27 in the defect management system 26. The recorded steps 16 may also be used as regression tests for AUT 12 in order to ensure the defect 13 does not reappear during various revisions, updates, and feature additions.

FIG. 5 is an example non-transitory computer readable medium 200 for storing instructions for defect assessment in DRA tool 20. The computer readable medium 200 is a non-transitory medium readable by a processor to execute the instructions stored therein. The non-transitory computer readable medium 200 includes a set of instructions organized in modules 202 which when the instruction are read and executed by the processor to cause the processor to perform the functions of the respective modules. While one particular example module organization is shown for understanding, those of skill in the art will recognize that the software may be organized in any particular order or combinations that implements the described functions and still meet the intended scope of the claims, in some examples, all the computer readable medium 200 may be non-volatile memory or partially non-volatile such as with battery backed up memory. The non-volatile memory may include magnetic, optical, flash, EEPROM, phase-change memory, resistive RAM memory, and/or combinations as Just some examples.

The computer readable medium 200 includes a first module 204 with instructions to receive a set of recorded steps 16 for a defect 13 and open a report 27 for the defect 13 in defect management system 26 along with attaching the recorded steps 16 to the report 27. A second module 206 includes instructions to extract a set of analytic calls from an analytic engine 22 generated from the recorded steps 16 for the defect 13. The analytic engine 22 continually assesses a severity level 46 of the defect 13 based on customer usage statistics 24 accumulated in the analytic engine 22 for the AUT 12. The statistics 24 include data to allow for calculation of a Usage Factor 42 and a Bounce Rate Factor 44 and the severity level 46 of the defect 13 is based on a mixture of the Usage Factor 42 and the Bounce Rate Factor 44. The mixture may be a simple average of the two factors or it may be a weighted average of two factors.

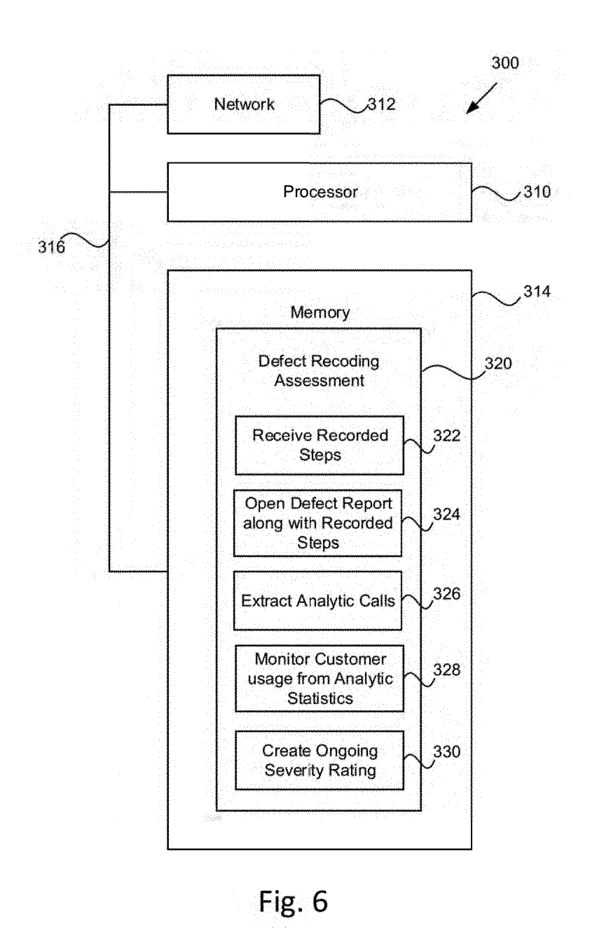

FIG. 6 is an example block diagram of a computer based system 300 implementing a DRA tool 20 with a defect recording assessment program. The system 300 includes a processor 310 which may be one or more central processing unit (CPU) cores, hyper threads, or one or more separate CPU units in one or more physical machines. For instance, the CPU may be a multi-core Intel™ or AMD™ processor or it may consist of one or more server implementations, either physical or virtual, operating separately or in one or more datacenters, including the use of cloud computing services. The processor 310 is communicatively coupled with a communication channel 316, such as a processor bus, optical link, etc, to one or more communication devices such as network 312, which may be a physical or virtual network interface, many of which are known to those of skill in the art, including wired and wireless mediums, both optical and radio frequency (RF) for communication.

Processor 102 is also communicatively coupled to local non-transitory computer readable memory (CRM) 314, such as cache and DRAM which includes a set of instructions organized in modules for defect recording assessment program 320 that when the instruction are read and executed by the processor to cause the processor to perform the functions of the respective modules. While a particular example module organization is shown for understanding, those of skill in the art will recognize that the software may be organized in any particular order or combinations that implements the described functions and still meet the intended scope of the claims. The CRM 314 may include a storage area for holding programs and/or data and may also be implemented in various levels of hierarchy, such as various levels of cache, dynamic random access memory (DRAM), virtual memory, file systems of non-volatile memory, and physical semiconductor, nanotechnology materials, and magnetic/optical media or combinations thereof, in some examples, all the memory may be non-volatile memory or partially non-volatile such as with battery backed up memory. The non-volatile memory may include magnetic, optical, flash, EEPROM, phase-change memory, resistive RAM memory, and/or combinations as just some examples.

A defect recording Assessment software program 320 may include one or more of the following modules. A first module 322 contains instructions to receive recorded steps 16 for a defect 13. A second module 324 has instructions to open a defect report 27 on a defect management system 26 along with the recorded steps 16 for the defect 13. A third module 326 contains instructions to interact with an analytic engine 22 to extract analytic calls related to the recorded steps 16. Fourth module 328 has instructions to monitor the consumer usage based on the analytic engine 22 statistics 24 over time. The fifth module 330 includes instructions to create an ongoing severity level 46.

There are several benefits of the disclosed DRA tool 20. For instance, there is an automatic objective-based classification of defect severity as well as ongoing and reclassification over time as the application is used. This objective-based technique replaces the idiosyncratic nature of the typical QAE/DevOp's subjective classification of a defect's severity. Further there is automatic opening and closing of defects by just using the recorded steps and defect severity level 46 assessment from the set of results 40. This feature reduces or eliminates the time that QAEs and DevOps often waste during ongoing testing in reproducing the relevant defect and the steps to replicate it. Thus, the DRA tool 20 allows QAEs and DevOps to perform higher value work rather than having to continually retest for defects particularly without even having any actual knowledge of how recorded steps for the defect are actually being used by customers. Accordingly, the severity level rating is tied more objectively to the actual customer expectations than the subjective judgment of QAEs/DevOps. Thus the overall quality of the application under test will be perceived better by users even if some defects remain unresolved as they will be the least severe defects based on customer usage patterns.

While the claimed subject matter has been particularly shown and described with reference to the foregoing examples, those skilled in the art will understand that many variations may be made therein without departing from the intended scope of subject matter in the following claims. This description should be understood to include all novel and non-obvious combinations of elements described herein, and claims may be presented in this or a later application to any novel and non-obvious combination of these elements. The foregoing examples are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A method for defect assessment operating on a processor, the processor executing instructions from processor readable memory, the instructions causing the processor to perform operations, comprising:
assessing a defect severity using extracted analytic calls from an analytic engine generated by a set of recorded steps for an application;
monitoring customer usage of the application to generate usage statistics over a time period from the analytic engine including a usage factor and a bounce rate factor; and
calculating an ongoing severity level from a mixture of the usage factor and the bounce rate factor.

2. The method of claim 1, further comprising:
opening a defect report and attaching the recorded steps to the defect report; and
closing the defect report when the ongoing severity level falls below a threshold.

3. The method of claim 1, further comprising connecting to a defect recording assessment system.

4. The method of claim 1, wherein when the bounce rate factor exceeds a predetermined level, the severity level is upgraded to critical,

5. The method of claim 1, wherein the recorded steps are used as application tests and periodically executed to determine if the defect is solved,

6. The method of claim 1, wherein the severity level is determined by a weighted combination of the usage factor and the bounce rate factor.

7. A system for defect assessment in an application, comprising:
a processor coupled to processor readable memory, the memory including instructions in modules executable by the processor to;
receive a set of recorded steps for the application;
connect to defect management system to open a defect report and attach the recorded steps to defect report;
extract analytic calls for an analytic engine generated from the recorded steps to assess a severity of the defect by monitoring and assessing customer usage of the application using usage statistics from the analytic engine over a time period including a usage factor and a bounce rate factor; and
calculating an ongoing severity level from a mixture of the usage factor and the bounce rate factor.

8. The system of claim 7, further comprising a module to close the defect report when the ongoing severity level fail below a threshold.

9. The system of claim 7, wherein when the bounce rate factor exceeds a predetermined level, the severity level is upgraded to critical.

10. The system of claim 7, wherein the severity factor is determined by a weighted combination of the usage factor and the bounce rate factor.

11. The system of claim 7, wherein the recorded steps are used as application tests and periodically executed to determine if the defect is solved and if solved, to close the defect report in the defect management system.

12. A non-transitory computer readable memory, comprising instructions readable by a processor to perform operations for defect assessment to:
receive a set of recorded steps and open a report for a defect along with attaching the recorded steps to the report; and
extract a set of analytic calls for an analytic engine generated from the recorded steps to continually assess a severity level of the defect based on customer usage statistics accumulated overtime in the analytic engine for the application, the statistics including a usage factor and a bounce rate factor and the severity level of the defect is based on a mixture of the usage factor and the bounce rate factor.

13. The non-transitory computer readable memory of claim 12, wherein the severity level of the defect is determined by a weighted combination of the usage factor and the bounce rate factor.

14. The non-transitory computer readable memory of claim 13, further comprising instructions to close the report if the ongoing severity level is below a threshold.

15. The non-transitory computer readable memory of claim 12, wherein when the bounce rate factor exceeds a predetermined level, the severity level is upgraded to critical.
